(19) United States
(12) Patent Application Publication
(10) Pub. No.: US 2017/0099812 A1
(43) Pub. Date: Apr. 13, 2017

(54) SMART CLOUD-BASED INTERACTIVE AQUARIAL DEVICE

(71) Applicant: TAIWAN ANJIE ELECTRONICS CO., LTD, Hsinchu City (TW)

(72) Inventor: YU-MING CHANG, Hsinchu City (TW)

(21) Appl. No.: 15/229,725

(22) Filed: Aug. 5, 2016

(30) Foreign Application Priority Data
Oct. 8, 2015 (TW) 104216264

(51) Int. Cl. A01K 63/00; A01K 63/06; A01K 63/04; A01K 61/02

(52) U.S. Cl. CPC A01K 63/006; A01K 61/025; A01K 63/06; A01K 63/065; A01K 63/042; H04L 67/10

(57) ABSTRACT

A smart cloud-based interactive aquarial device, mounted on an aquarium and connected to at least one cloud server to communicate with an electronic device through the cloud server, including an image capturing device for capturing images in the aquarium; at least one peripheral control device including a feeding member for feeding fish foods into the aquarium automatically or according to a feeding instruction of the electronic device; a processing module connected to the image capturing device and the peripheral control device to control operation thereof; and a wireless communication module for enabling the smart cloud-based interactive aquarial device to communicate with the cloud server or the electronic device, sending images captured by the image capturing device to the cloud server for storage and sending at least one instruction to the processing module through the cloud server.

### CROSS-REFERENCE TO RELATED APPLICATION

This non-provisional application claims priority under 35 U.S.C. §119(a) on Patent Application No(s).104216264 filed in Taiwan, R.O.C. on Oct. 8, 2015, the entire contents of which are hereby incorporated by reference.

### FIELD OF THE INVENTION

The present invention relates to devices for remotely controlling aquariums and, more particularly, to a smart cloud-based interactive aquarial device.

### BACKGROUND OF THE INVENTION

Modern life is so busy and stressful that it encourages people to keep pets. Raising cats and dogs can be as torturing as raising kids. In view of this, some people choose to raise aquarial creatures, such as fishes and turtles, and for additional reasons. Aquarial creatures serve as good companions. Aquariums enhance aesthetic perception of indoor environments. The aquarial presence is considered auspicious from the perspective of feng shui.

Although fishes are easier to raise than cats and dogs, fishes are fragile—a change in circumstances, however small, may cause fishes to become sick and even die. Hence, raising fishes is no easy job, as it entails maintaining water temperature and water quality and dispensing fish foods at a fixed time and in a fixed amount correctly. Furthermore, a feeder will be confronted with problems arising from his or her aquarium, if s/he is not at home for more than a day and is unable to carry the aquarium during his or her absence or find a caretaker. Conventional automatic-circulation water purifying apparatuses can be mounted on aquariums, but they are expensive, bulky and functionally exclusive. Taiwan patent 283623, entitled Automatic Feeding Apparatus for use with Aquarium, discloses dispensing fish foods automatically, but it requires an air blower which blows out the fish foods by a difference between an internal pressure and an external pressure and is not connected to any external network and thus necessitates human control. As a result, Taiwan patent 283623 fails to solve the problems arising from an aquarium while the aquarium owner, i.e., the feeder, is away from home for a long period of time.

Accordingly, the present invention provides a smart cloud-based interactive aquarial device described below.

### SUMMARY OF THE INVENTION

It is an objective of the present invention to provide a smart cloud-based interactive aquarial device conducive to interaction between an aquarium and a feeder so that the feeder can watch fish kept in the aquarium on the screen of a smart device by cloud technology and take care of the fish.

Another objective of the present invention is to provide a smart cloud-based interactive aquarial device which enables fish food feeding to be carried out at a fixed time and in a fixed amount, enables an instruction to be sent from a smart device in a remotely-controlled manner, and enables fish foods to be fed automatically into an aquarium at home by controlling a feeding member of the aquarium through a cloud server, to allow a feeder away from home to take care of the fish kept in the aquarium, thereby preventing the fish from starving.

In order to achieve the above and other objectives, the present invention provides a smart cloud-based interactive aquarial device, mounted on an aquarium and connected to at least one cloud server to communicate with an electronic device interactively through the cloud server, the smart cloud-based interactive aquarial device comprising: an image capturing device for capturing images in the aquarium; at least one peripheral control device including a feeding member for feeding fish foods into the aquarium automatically or according to at least one feeding instruction of the electronic device; a processing module connected to the image capturing device and the peripheral control device to control operation thereof; and a wireless communication module connected to the processing module to enable communication between the smart cloud-based interactive aquarial device and the cloud server or allow the smart cloud-based interactive aquarial device to communicate with the electronic device through the cloud server, sending images captured by the image capturing device to the cloud server for storage and sending at least one instruction to the processing module through the cloud server.

The present invention further provides a water content-detecting and heating component for detecting water content of the fish foods and heating to reduce the water content in response to an increase in the water content, thereby preventing the fish foods from being dampened.

The present invention further provides a fry nurturing box set for replacing the feeding member such that a fry is placed in the fry nurturing box set and isolated from fish in the aquarium, so as to ensure that the fry will grow rather than be eaten by any large fish.

The present invention further provides a lighting effect device including a plurality of color light emitting components mounted on the aquarium, and adapted to configure colors of light emitted, flickering speed, flickering count and on/off of the lighting effect device through the electronic device, wherein the way the lighting effect device emits light and flickers is controlled by musical rhyme.

The present invention further provides a water temperature monitoring device for not only monitoring a water temperature of the aquarium but also automatically sending the water temperature to the electronic device through the cloud server so as to inform a feeder of the water temperature in real time such that the feeder can automatically regulate the water temperature.

The present invention further provides a water quality monitoring device for monitoring the water quality in the aquarium and sending water quality-related data to the remotely-located feeder through the cloud server to inform the feeder of the water quality in the aquarium in real time.

The present invention further provides a virtual background projection device for receiving a wallpaper image through the cloud server and projecting the wallpaper image on to a surface of the aquarium, so as to form a background frame of the aquarium and enhance the beauty of the aquarium.

The present invention further provides a laser pointing device for generating at least one laser point movable on the aquarium to make fun of fish and thus interact with the fish.

The present invention further provides a backup power system such that, in response to a failure of the power device to supply power, the first processing device automatically switches to the backup power system, thereby protecting the fish against hypoxia which might otherwise occur whenever the air pump stops operating due to a power outage.

Preferred embodiments are described below to illustrate the objectives, technical features, and advantages of the present invention.

### BRIEF DESCRIPTION OF THE DRAWINGS

FIG. 1 is a block diagram of a smart cloud-based interactive aquarial device connected to an electronic device through a cloud server according to the present invention; and

FIG. 2 is a schematic view of the smart cloud-based interactive aquarial device mounted on the aquarium according to an embodiment of the present invention.

### DETAILED DESCRIPTION OF THE PREFERRED EMBODIMENTS

The present invention provides a smart cloud-based interactive aquarial device mounted on an aquarium and connected to at least one cloud server to communicate with an electronic device through the cloud server so that, while being away from home, a feeder can watch fish s/he keeps at home and interact with the fish.

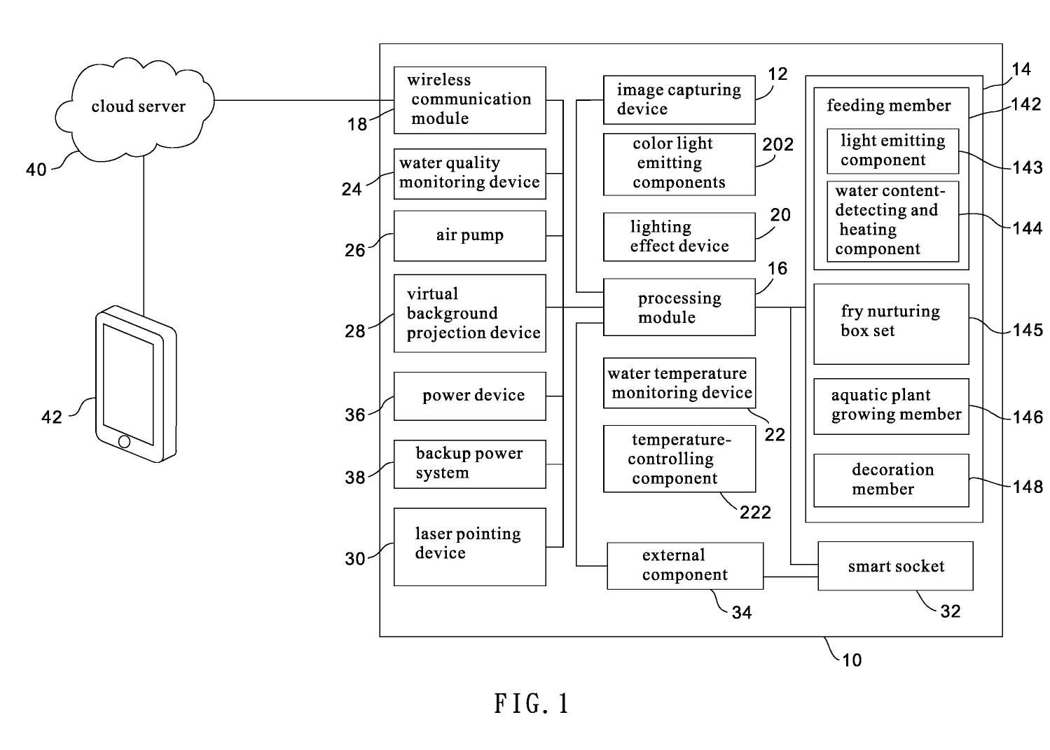

Referring to FIG. 1, there is shown a smart cloud-based interactive aquarial device 10 connected to an electronic device 42 through a cloud server 40 according to the present invention. The smart cloud-based interactive aquarial device 10 is mounted on an aquarium (not shown) and comprises an image capturing device 12, at least one peripheral control device 14, a processing module 16 and a wireless communication module 18. The image capturing device 12, exemplified by a camera, a camcorder or a mini camcorder, captures images of the aquarium from different angles of view. The peripheral control device 14 comprises a feeding member 142 for feeding fish foods automatically into the aquarium according to the settings in the processing module 16 or feeding fish foods into the aquarium according to a feeding instruction sent in a remotely-controlled manner from the electronic device 42, wherein the feeding time and feed food quantity of the feeding member 142 is placed under control. The processing module 16 connects with all the apparatuses in the smart cloud-based interactive aquarial device 10 to control the operation thereof. The wireless communication module 18 enables the smart cloud-based interactive aquarial device 10 to communicate with the cloud server 40 or the electronic device 42; hence, not only is data pertaining to the images captured by the image capturing device 12 sent to the cloud server 40 for storage, but at least one instruction is also sent to the processing module 16 through cloud server 40. The instruction is sent from the electronic device 42 instantly. Alternatively, the instruction is stored in the cloud server 40 beforehand and then sent to the processing module 16 as needed.

With the cloud server 40, the feeder can share with counterparts the real-time images of fishes kept in aquariums at home.

The feeding member 142 further comprises a light-emitting component 143. Before the feeding session begins, the light-emitting component 143 emits light to attract the fish so that the fish foods fed into the aquarium are eaten by the fish instantly rather than ignored by the fish. The fish foods fed but ignored rot as time passes by, thereby compromising the water quality in the aquarium. The feeding member 142 also enables the feeder to watch in a remotely-controlled manner the fish raised at home. The feeding member 142 further comprises a water content-detecting and heating component 144 for detecting the water content of the fish food and automatically heating the fish food to dry the fish food as soon as the water content thereof rises to an undesirable level, thereby preventing the fish food from dampening.

The peripheral control device 14 further comprises a fry nurturing box set 145 which replaces the feeding member 142. At least one fry is placed in the fry nurturing box set 142 and isolated from the fish of the aquarium to not only ensure that the fry will grow rather than be eaten by any large fish but also prevent the fry from starving if the fish foods are entirely eaten by the large fish.

The peripheral control device 14 further comprises an aquatic plant growing member 146 and a decoration member 148 which replace the feeding member 142. The aquatic plant growing member 146 is for growing aquatic plants in the aquarium. The decoration member 148 is for enhancing the beauty of the aquarium by adding to the variability of the aquarium. The decoration member 148 may come in the form of artificial hills, rocks and bridges for the fish to play and hide around.

To enhance the beauty of the aquarium, the smart cloud-based interactive aquarial device 10 further comprises a lighting effect device 20. The lighting effect device 20 includes a plurality of color light emitting components 202 mounted on the aquarium. The feeder may configure the colors of light emitted, flickering speed, flickering count and on/off of the lighting effect device 20 with the electronic device 42. An instruction given by the electronic device 42 is sent to the processing module 16 of the smart cloud-based interactive aquarial device 10 through the cloud server 40. Then, depending on the instruction, the processing module 16 controls the lighting effect device 20 to turn on/off, emit light and flicker. The instruction sent from the electronic device 42 comes in various forms, including selecting an intended lighting effect, or generating a sound for remotely controlling the lighting effect device 20 to emit light, for example, making a sound “ding-dong” to trigger the color light emitting components 202 to emit light. Furthermore, the lighting effect device 20 may turn on/off, emit light and flicker according to rhyme changes, colors of light emitted and flickering speed. For example, as soon as the music played by the electronic device 42 features speedy rhymes, the color light emitting components 202 have a high flickering frequency, and, likewise, slow rhymes lead to a low flickering frequency. Also, the color light emitting components 202 emit red light in response to high pitch of the music played by the electronic device 42, blue light in response to medium pitch, and green light in response to low pitch. The aforesaid variations and conditions can be configured with the electronic device 42 by the feeder.

To make the aquarium cozy and keep the fish fit, the smart cloud-based interactive aquarial device 10 further comprises a water temperature monitoring device 22 and a water quality monitoring device 24. The water temperature monitoring device 22 monitors water temperature in the aquarium, sends data pertaining to the water temperature to the cloud server 40, and reports the water temperature to the feeder in real time or as needed (for example, when the water temperature reaches an abnormal level or a feeder-defined level). The water temperature monitoring device 22 further comprises a temperature-controlling component 222 for automatically regulating the water temperature to ensure that the water temperature always stays at a predetermined value (at which the fish fare best). The water quality monitoring device 24 monitors water quality in the aquarium, including pH value, dissolved oxygen levels, electrical conductivity, and residual chlorine, whereas data pertaining thereto is stored in the cloud server 40 and sent to the electronic device 42 of the remotely-located feeder through the cloud server 40, thereby allowing the feeder to keep track of water quality in the aquarium at home. If the data received by the feeder is abnormal, the feed will determine whether to return home to change water or take any other action, for example, adding a water quality stabilizing agent to the aquarium by remote control to stabilize the water quality. In practice, it is the feeding member 142 which adds the water quality stabilizing agent to the aquarium upon receipt of a related instruction.

After detecting a low dissolved oxygen level, the water quality monitoring device 24 sends a request message to the processing module 16 to request it to start an air pump 26. Upon receipt of the request message, the processing module 16 starts the air pump 26 whereby the aquarium is aired to increase the dissolved oxygen level until the aquarium restores the normal dissolved oxygen level and the processing module 16 no longer receives the request message from the water quality monitoring device 24 or does receive a request message which requests the air pump 26 to stop operating because the dissolved oxygen level has become normal.

The present invention further provides a virtual background projection device 28 located at the aquarium. The virtual background projection device 28 is a micro-projector disposed beside the aquarium. With the electronic device 42, the feeder downloads a computer wallpaper image by a network. Then, the wallpaper image is sent to the virtual background projection device 28 through the cloud server 40. After the virtual background projection device 28 has received wallpaper image, a background frame for the aquarium is produced by projecting the received wallpaper image onto the other side of the aquarium corresponding in position to the virtual background projection device 28 to enhance the beauty of the aquarium. Afterward, the feeder may change the wallpaper image as needed.

To make fun by raising fish, the present invention further provides a laser pointing device 30 for generating at least one laser point movable on the aquarium with the electronic device 42, and the electronic device 42 controls the direction in which the at least one laser point travels, thereby allowing the feeder to make fun of fish and thus interact with the fish.

The smart cloud-based interactive aquarial device 10 further has a smart socket 32. The smart socket 32 is connected to the processing module 16. At least one external component 34, such as an illumination device, an air pump, a heating rod, an atmosphere lamp, and/or a foam generator, is connected to the smart socket 32. The at least one external component 34 is turned on/off through the cloud server 40. Alternatively, the operation of the at least one external component 34 is controlled through the cloud server 40. Hence, the functionality of the smart cloud-based interactive aquarial device 10 can be expanded, and all the functions of the smart cloud-based interactive aquarial device 10 can be remotely and conveniently controlled by the remotely-located feeder.

For example, the feeder purchases a heating rod and plugs it into the smart socket 32, so as for the heating rod to operate in conjunction with the water temperature monitoring device 22. Upon receipt of a report of a low water temperature, the feeder starts the heating rod through the cloud server 40, or the smart socket 32 (or the processing module 16) automatically starts the heating rod. Upon detection of a high water temperature by the water temperature monitoring device 22, the smart socket 32 interrupts power supply to the heating rod to prevent the water temperature in the aquarium from rising.

The smart cloud-based interactive aquarial device 10 comes with a power device 36 connected to a socket power for meeting all sorts of power requirements of the smart cloud-based interactive aquarial device 10. In case the power device 36 fails to supply power, for example, because of a power outage or a breakdown of the power device 36, the processing module 16 automatically switches to a backup power system 38 to ensure that not only the air pump 26 will keep operating and airing the aquarium but also both the feeding member 142 and the heating rod will operate as needed.

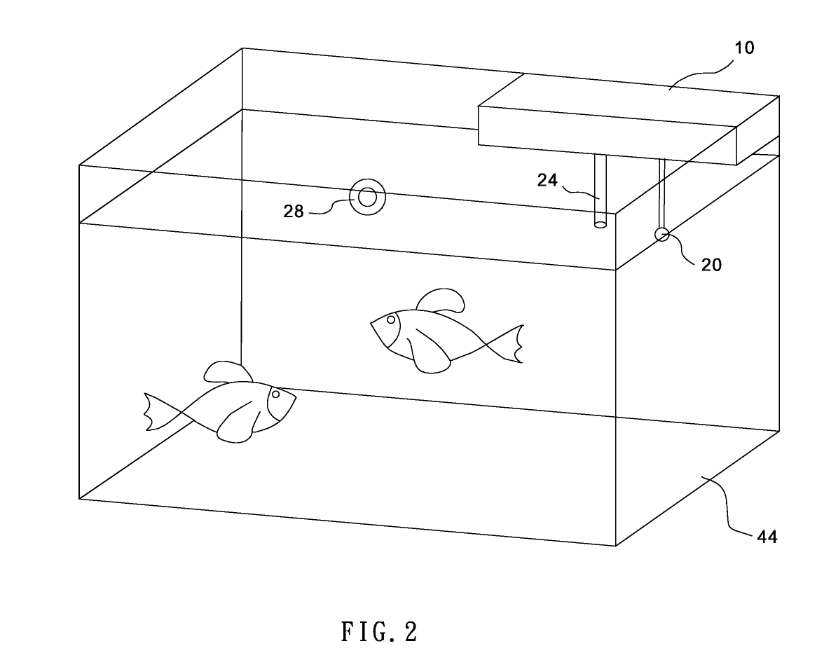

FIG. 2 is a schematic view of the smart cloud-based interactive aquarial device 10 mounted on the aquarium according to an embodiment of the present invention. The smart cloud-based interactive aquarial device 10 is either provided in one unit or composed of members. Referring to FIG. 2, in an embodiment, the smart cloud-based interactive aquarial device 10 is provided in one unit, and, as a result, it is only when the virtual background projection device 28 is positioned on the front of the aquarium 44 that the wallpaper image can be projected onto the rear side of the aquarium 44 to produce the background frame thereof. Furthermore, the water temperature monitoring device 22 and the water quality monitoring device 24 are positioned beneath the smart cloud-based interactive aquarial device 10 to measure the water temperature and collect water samples, respectively.

In conclusion, the smart cloud-based interactive aquarial device of the present invention is characterized in that: the interaction between the feeder and the aquarium through the cloud server enables fish kept in the aquarium at home to be watched by the feeder with a smart device and by cloud technology; in doing so, even when away from home, the feeder can take care of the fish through the cloud server and share instant images taken of the aquarium and the fish with the other feeders equipped with the smart cloud-based interactive aquarial device, thereby achieving person-fish interaction as well as interpersonal interaction.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A smart cloud-based interactive aquarial device, mounted on an aquarium and connected to at least one cloud server to communicate with an electronic device interactively through the cloud server, the smart cloud-based interactive aquarial device comprising:
an image capturing device for capturing images in the aquarium;
at least one peripheral control device including a feeding member for feeding fish foods into the aquarium automatically or according to at least one feeding instruction of the electronic device;
a processing module connected to the image capturing device and the peripheral control device to control operation thereof; and
a wireless communication module connected to the processing module to enable communication between the smart cloud-based interactive aquarial device and the cloud server or allow the smart cloud-based interactive aquarial device to communicate with the electronic device through the cloud server, sending images captured by the image capturing device to the cloud server for storage and sending at least one instruction to the processing module through the cloud server.

2. The smart cloud-based interactive aquarial device of claim 1, wherein the feeding member is remotely controlled with configurations in the processing module or by the electronic device to control a feeding time and a fish food quantity of the feeding member.

3. The smart cloud-based interactive aquarial device of claim 1, wherein the feeding member further comprises a light-emitting component for emitting light to attract fish before feeding fish foods into the aquarium.

4. The smart cloud-based interactive aquarial device of claim 1, wherein the feeding member further comprises a water content-detecting and heating component for detecting water content of the fish foods and heating to reduce the water content in response to an increase in the water content.

5. The smart cloud-based interactive aquarial device of claim 1, wherein the peripheral control device further comprises a fry nurturing box set for replacing the feeding member such that at least one fry is placed in the fry nurturing box set and isolated from fish in the aquarium.

6. The smart cloud-based interactive aquarial device of claim 1, wherein the peripheral control device further comprises an aquatic plant growing member for replacing the feeding member and growing aquatic plants in the aquarium.

7. The smart cloud-based interactive aquarial device of claim 1, wherein the peripheral control device further comprises a decoration member for replacing the feeding member and enhancing beauty of the aquarium.

8. The smart cloud-based interactive aquarial device of claim 1, further comprises a lighting effect device connected to the processing module, including a plurality of color light emitting components mounted on the aquarium, and adapted to configure colors of light emitted, flickering speed, flickering count and on/off of the lighting effect device through the electronic device.

9. The smart cloud-based interactive aquarial device of claim 8, wherein the electronic device generates a sound for remotely controlling the lighting effect device to emit light, or the electronic device plays music to control the lighting effect device to emit light and flicker.

10. The smart cloud-based interactive aquarial device of claim 1, further comprising a water temperature monitoring device connected to the processing module to not only monitor a water temperature of the aquarium but also automatically send the water temperature to the electronic device through the cloud server so as to inform a feeder of the water temperature.

11. The smart cloud-based interactive aquarial device of claim 10, wherein the water temperature monitoring device further comprises a temperature-controlling component for automatically raising or lowering the water temperature.

12. The smart cloud-based interactive aquarial device of claim 1, further comprising a water quality monitoring device connected to the processing module for monitoring water quality in the aquarium.

13. The smart cloud-based interactive aquarial device of claim 12, wherein the water quality monitoring device monitors data, including pH value, dissolved oxygen level, electrical conductivity, residual chlorine, and uploads the data to the cloud server.

14. The smart cloud-based interactive aquarial device of claim 12, further comprising an air pump for turning on automatically to start as soon as the water quality monitoring device detects that the dissolved oxygen level is overly low and turning off automatically to stop as soon as the dissolved oxygen level becomes normal.

15. The smart cloud-based interactive aquarial device of claim 1, further comprising a virtual background projection device connected to the processing module to receive a wallpaper image through the cloud server and project the wallpaper image on to a surface of the aquarium with the virtual background projection device.

16. The smart cloud-based interactive aquarial device of claim 15, wherein the virtual background projection device is a micro-projector.

17. The smart cloud-based interactive aquarial device of claim 1, further comprising a laser pointing device connected to the processing module to generate at least one laser point movable on the aquarium.

18. The smart cloud-based interactive aquarial device of claim 17, wherein a direction in which the at least one laser point emitted from the laser pointing device travels is controlled with the electronic device.

19. The smart cloud-based interactive aquarial device of claim 1, further comprising a smart socket connected to the processing module such that at least one external component connected to the smart socket is turned on/off through the cloud server, or operation of the at least one external component connected to the smart socket is controlled through the cloud server.

20. The smart cloud-based interactive aquarial device of claim 19, wherein the external component is one of an illumination device, an air pump, a heating rod, an atmosphere lamp, and a foam generator.

21. The smart cloud-based interactive aquarial device of claim 1, further comprising a power device connected to an electrical outlet to supply power to the smart cloud-based interactive aquarial device.

22. The smart cloud-based interactive aquarial device of claim 21, further comprising a backup power system connected to the processing module such that, in response to a failure of the power device to supply power, the first processing device automatically switches to the backup power system.
